(19) United States
(12) Patent Application Publication
(10) Pub. No.: US 2020/0065057 A1
(43) Pub. Date: Feb. 27, 2020

(54) AUDIO ADJUSTING DEVICE, COMPUTER-READABLE NON-TRANSITORY STORAGE MEDIUM STORING CONTROL PROGRAM, ELECTRONIC APPARATUS, AND METHOD FOR CONTROLLING AUDIO ADJUSTING DEVICE

(71) Applicant: SHARP KABUSHIKI KAISHA, Sakai City, Osaka (JP)

(72) Inventors: KAZUNORI WAKI, Sakai City (JP); KEI OKUDA, Sakai City (JP); YOSHIKO IMAKI, Sakai City (JP); HIROYUKI OONISHI, Sakai City (JP); FUMITOSHI TANOUE, Sakai City (JP); SATOSHI EGUCHI, Sakai City (JP)

(21) Appl. No.: 16/345,935

(22) PCT Filed: Aug. 31, 2017
(86) PCT No.: PCT/JP2017/031459

§ 371 Date: Apr. 29, 2019

(30) Foreign Application Priority Data
Nov. 8, 2016 (JP) 2016-218445

(51) Int. Cl. G06F 3/16; G10L 13/04; G10L 15/22

(52) U.S. Cl. CPC G06F 3/165; G06F 3/167; G10L 2015/223; G10L 15/22; G10L 13/043

(57) ABSTRACT

An aspect of the present invention allows a natural, humanlike conversation to be carried out between electronic apparatus. The audio adjustment device (1) includes: a sound analyzing section (21) for analyzing a second sound outputted from a second electronic apparatus; and an element adjusting section (24) for adjusting a first element characterizing the first sound, the first element being adjusted on a basis of either a content of a text in the second sound or a second element characterizing the second sound, the content of the text in the second sound and the second element being obtained by analysis by the sound analyzing section (21).

### TECHNICAL FIELD

The present invention relates to an audio adjustment device, a control program, an electronic apparatus and a method for controlling the audio adjustment device.

### BACKGROUND ART

In recent years, research and development has been actively carried out on devices/apparatuses, such as interactive robots, capable of carrying out a conversation with a conversational partner. For example, Patent Literature 1 discloses a communication robot including: an output section for outputting, as a sound of a speech, a conversation pattern of the communication robot; and an interactive reaction detecting section for determining whether or not the sound of the speech of the communication robot could be heard by an interlocutor, which output section adjusts and re-outputs the sound of the speech in a case where the interactive reaction detecting section determines that the interlocutor could not hear the sound of the speech.

The communication robot can check whether the interlocutor could hear the sound of the speech of the communication robot and readjust the sound of the speech. Therefore, the interlocutor can smoothly communicate with the communication robot, without feeling stress.

### CITATION LIST

### Patent Literature

[Patent Literature 1]

Japanese Patent Application Publication Tokukai No. 2016-118592 (Publication date: Jun. 30, 2016)

### SUMMARY OF INVENTION

### Technical Problem

However, the communication robot disclosed in Patent Literature 1 is merely a robot which can appropriately adjust a sound to be generated in a case where the conversation partner is a human. Patent Literature 1 neither discloses nor suggests a technique for adjusting a sound to be generated in a case where the conversation partner is another interactive robot. Therefore, the communication robot disclosed in Patent Literature 1 cannot adjust a sound generated in a conversation with another interactive robot. As a result, when a human listens to a conversation between the communication robot and an interactive robot, the human may feel that the conversation is unnatural.

An aspect of the present invention has been attained in view of the above problem. An object of an aspect of the present invention is to provide a device which adjusts a sound to be outputted from an electronic apparatus so that the electronic apparatus can carry out a natural, humanlike conversation with another electronic apparatus.

### Solution to Problem

In order to solve the above problem, an audio adjustment device according to an aspect of the present invention is configured to be an audio adjustment device for adjusting a first sound to be outputted from a first electronic apparatus, the audio adjustment device including: a sound analyzing section for analyzing a second sound outputted from a second electronic apparatus; and an element adjusting section for adjusting a first element characterizing the first sound, the first element being adjusted on a basis of either a content of a text in the second sound or a second element characterizing the second sound, the content of the text in the second sound and the second element being obtained by analysis by the sound analyzing section.

In order to solve the above problem, an electronic apparatus according to an aspect of the present invention is configured to be an electronic apparatus for adjusting a first sound to be outputted from the electronic apparatus, the electronic apparatus including: a sound analyzing section for analyzing a second sound outputted from an external electronic apparatus; and an element adjusting section for adjusting a first element characterizing the first sound, the first element being adjusted in accordance with either a content of a text in the second sound or a second element characterizing the second sound, the content of the text in the second sound and the second element being obtained by analysis by the sound analyzing section.

In order to solve the above problem, a method for controlling an audio adjustment device according to an aspect of the present invention is configured to be a method for controlling an audio adjustment device for adjusting a first sound to be outputted from a first electronic apparatus, the control method including the steps of: analyzing a second sound having been outputted from a second electronic apparatus; and adjusting a first element characterizing the first sound, the first element being adjusted on a basis of either a content of a text in the second sound or a second element characterizing the second sound, the content of the text in the second sound and the second element having been obtained by analysis in the step of analyzing the second sound.

### Advantageous Effects of Invention

Each of the audio adjustment device, the electronic apparatus, and the method for controlling the audio adjustment device according to aspects of the present invention advantageously allows the electronic apparatus to carry out a natural, humanlike conversation with another electronic apparatus.

### BRIEF DESCRIPTION OF DRAWINGS

FIG. 1 is a block diagram illustrating a functional configuration of a robot according to each of Embodiments 1 and 2 of the present invention.

FIG. 2 is a flowchart showing an example flow of characteristic operations of robots according to Embodiment 1 of the present invention.

(a) of FIG. 3 is a flowchart showing another example flow of characteristic operations of robots according to Embodiment 1 of the present invention. (b) of FIG. 3 is a diagram showing an example of a conversation between the robots according to Embodiment 1 of the present invention.

(a) of FIG. 4 is a flowchart showing another example flow of characteristic operations of robots according to Embodiment 1 of the present invention. (b) of FIG. 4 is a diagram showing another example of a conversation between the robots according to Embodiment 1 of the present invention.

(a) of FIG. 5 is a flowchart showing another example flow of characteristic operations of robots according to Embodiment 1 of the present invention. (b) of FIG. 5 is a diagram showing another example of a conversation between the robots according to Embodiment 1 of the present invention.

FIG. 6 is a flowchart showing another example flow of characteristic operations of a robot according to Embodiment 1 of the present invention.

FIG. 7 is a diagram showing another example of a conversation between robots according to Embodiment 1 of the present invention.

FIG. 8 is a block diagram illustrating a functional configuration of a robot according to a variation of Embodiment 1 of the present invention.

### DESCRIPTION OF EMBODIMENTS

### Embodiment 1

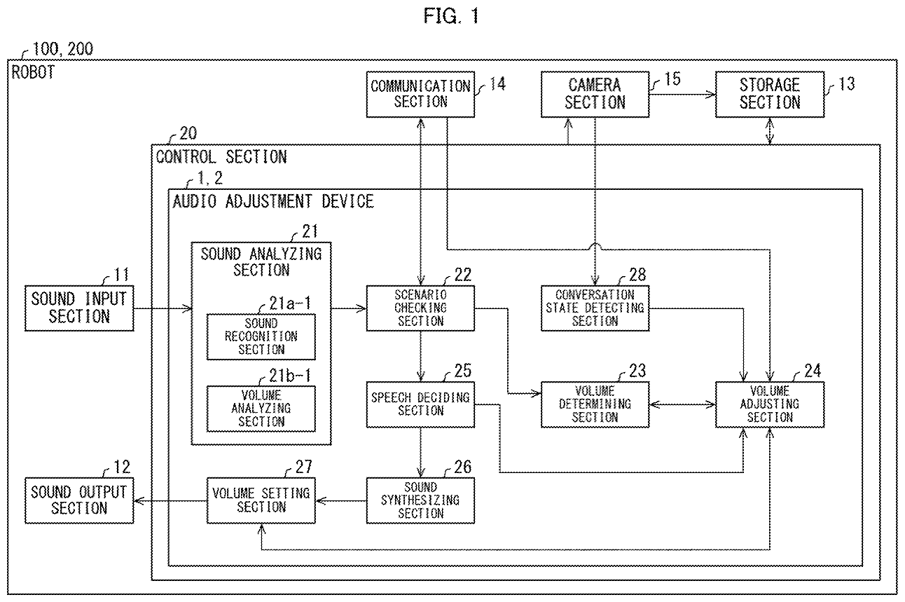

The following will discuss an embodiment of the present invention, with reference to FIGS. 1 to 8. For convenience of description, any components that are identical in function to the components described in particular sections are assigned the same reference signs, and descriptions thereof are omitted.

Note that embodiments below each will discuss a robot as an example of an electronic apparatus including an audio adjustment device according to an aspect of the present invention. Examples of such an electronic apparatus, on which the audio adjustment device according to an aspect of the present invention can be mounted, encompass mobile terminals and home electric appliances such as refrigerators in addition to robots.

Further, the audio adjustment device according to an aspect of the present invention does not necessarily have to be mounted on an electronic apparatus as described above. For example, the audio adjustment device according to an aspect of the present invention can be mounted on an external information processing device. In this configuration, transmission and reception of information on a sound (voice) of the robot and information on a sound (voice) of another robot as a conversation partner can be carried out between the external information processing device and these two robots, so that the sounds of these robots are to be adjusted.

Furthermore, though the embodiments below each will describe a conversation between two robots as an example, the audio adjustment device according to an aspect of the present invention can be applied to a conversation between three or more robots.

<Functional Configuration of Robot>

First, the following will discuss a functional configuration of a robot 100 according to an embodiment of the present invention, with reference to FIG. 1. FIG. 1 is a block diagram illustrating the functional configuration of the robot 100. The robot 100 (first electronic apparatus, or electronic apparatus) is a communication robot capable of carrying out a conversation with another robot (second electronic apparatus; hereinafter, referred to as a “partner robot”).

The robot 100 can appropriately adjust a first sound to be outputted from the robot 100, in accordance with a second sound outputted from the partner robot. As a result of this adjustment, the robot 100 and the partner robot can have a natural, humanlike conversation. As shown in FIG. 1, the robot 100 includes a sound input section 11, a sound output section 12, a storage section 13, a communication section 14, and a control section 20.

Specifically, the sound input section 11 can be any sound collecting device such as a microphone. When the sound input section 11 detects a speech (content of a text in the second sound) of the partner robot, the sound input section 11 transmits the speech as audio data to a sound analyzing section 21 (described later). Note that it is desirable that the sound input section 11 identifies a single speech (speech composed of a sentence or a group of sentences) on the basis of, for example, a pause between speeches of the partner robot (a time in which the partner robot emits no sound), and transmits audio data of the single speech to the sound analyzing section 21.

The sound output section 12 functions as an output section for outputting, to the outside of the robot 100, audio data (first sound) received from a sound synthesizing section 26 (described later). Specifically, the sound output section 12 outputs the first sound which has been synthesized by the sound synthesizing section 26 on the basis of a content of a text in a speech which has been decided by a speech deciding section 25 (described later). The sound output section 12 is realized by, for example, a speaker which is provided in the robot 100. Note that though the sound output section 12 is built in the robot 100 in FIG. 1, the sound output section 12 can be an external device which is attached to the robot 100.

The storage section 13 stores various data which are handled by the robot 100. The communication section 14 communicates (establishes a communication protocol) with the partner robot. Note that the robot 100 can receive actual data containing personal data from the partner robot via the communication section 14.

The control section 20 collectively controls each section of the robot 100, and includes an audio adjustment device 1. Note that though the control section 20 is built in the robot 100 in FIG. 1, the control section 20 can be an external device attached to the robot 100 or a network server used via the communication section 14.

The audio adjustment device 1 is a device for adjusting the first sound to be outputted from the robot 100. When the second sound outputted from the partner robot is inputted to the robot 100, the audio adjustment device 1 adjusts the first sound of the robot 100. As shown in FIG. 1, the audio adjustment device 1 includes the sound analyzing section 21, a scenario checking section 22, a volume determining section 23 (element determining section), a volume adjusting section 24 (element adjusting section), the speech deciding section 25, the sound synthesizing section 26, and a volume setting section 27.

The sound analyzing section 21 analyzes the second sound outputted from the partner robot. The sound analyzing section 21 includes a sound recognition section 21a-1 and a volume analyzing section 21b-1. The sound recognition section 21a-1 performs sound recognition of audio data of a single speech of the partner robot, which audio data has been received from the sound input section 11. The term “sound recognition” herein refers to a process of obtaining text data indicating a content of a text in a speech (inputted content) from the audio data of the speech. A method of the sound recognition by the sound recognition section 21a-1 is not particularly limited. The speech recognition can be performed by using any conventional method.

The volume analyzing section 21b-1 analyzes audio data of a single speech of the partner robot, which single speech has been received from the sound input section 11, and obtains volume data of the speech. Note that although the sound analyzing section 21 is built in the robot 100 in FIG. 1, the sound analyzing section 21 can be, for example, an external device attached to the robot 100 or a network server used via the communication section 14.

The scenario checking section 22 identifies (confirms) which speech in a predetermined conversation scenario corresponds to a result of the speech recognition by the sound analyzing section 21 (sound recognition section 21a-1). Then, the scenario checking section 22 transmits a result of this identification to the volume determining section 23, the volume adjusting section 24, and the speech deciding section 25. The conversation scenario shows speeches to be exchanged between the robot 100 and the partner robot. Note that the term “result of speech recognition” refers to text data indicating a content of a single speech of the partner robot, in other words, a content of a text in a sound of the partner robot, which sound has been inputted to the sound input section 11.

Data of the conversation scenario is transmitted and received between the robot 100 and the partner robot. The data of the conversation scenario is stored in the form of a data table (not shown) in the scenario checking section 22. Note that the data of the conversation scenario need not necessarily be stored in the scenario checking section 22. The data of the conversation scenario can be stored, for example, in the storage section 13, or in an external device attached to the robot 100.

Note also that the scenario checking section 22 can be configured to identify which speech in the conversation scenario corresponds to a speech of the robot 100, and transmits, for each speech, a result of this identification to the partner robot via the communication section 14. Alternatively, the scenario checking section 22 can be configured to receive, from the partner robot via the communication section 14, the result of the identification regarding which speech in the conversation scenario corresponds to a speech of the partner robot.

The volume determining section 23 determines, with regard to a volume of the second sound of the partner robot which volume has been obtained by analysis by the sound analyzing section 21, whether or not the value is a predetermined value. The predetermined value is a volume value which is set in association with each speech of the partner robot in the conversation scenario. The predetermined value is stored in the data table (not shown) of the conversation scenario.

Next, on the basis of a result of the above determination and the result of the identification by the scenario checking section 22, the volume determining section 23 confirms that the content of the text in the second sound of the partner robot, which content is recognized by the sound analyzing section 21, is one of speeches of the partner robot in the conversation scenario.

The volume determining section 23 can confirm that the speech of the partner robot is a speech in the conversation scenario, only by determining, with regard to the volume of the second sound of the partner robot which sound has been recognized by the sound analyzing section 21, the volume is the predetermined value. That is, the volume determining section 23 can confirm that the speech of the partner robot associated with the predetermined value is a speech of the partner robot in the conversation scenario in a case where the volume determining section 23 determines that the volume of the second sound of the partner robot is the predetermined value.

The above determination by the volume determining section 23 is not necessarily performed with use of the predetermined value. The determination by the volume determining section 23 can be based on whether or not the volume of the second sound of the partner robot, which volume has been obtained by the analysis by the sound analyzing section 21, satisfies a predetermined condition.

The volume adjusting section 24 adjusts a volume of the first sound to be outputted from the sound output section 12, i.e., the robot 100, in accordance with a confirmation result which is received from the volume determining section 23. Specifically, in a case where the volume determining section 23 confirms that the content of the text in the speech of the partner robot, which content has been recognized by the sound analyzing section 21, is one of the speeches of the partner robot in the conversation scenario, the volume adjusting section 24 adjusts the volume of the first sound. On the other hand, in a case where the volume determining section 23 cannot confirm that the content of the text in the speech of the partner robot is one of the speeches of the partner robot in the conversation scenario, the volume adjusting section 24 does not adjust the volume of the first sound, and the sound output section 12 does not output the first sound.

In a case where the volume determining section 23 could confirm that the content of the text in the speech of the partner robot is one of the speeches of the partner robot in the conversation scenario, the volume adjusting section 24 searches the conversation scenario for a speech which is a reply to the speech identified by the scenario checking section 22. Then, the volume adjusting section 24 specifies the speech, which is a search result, for a content of a text in the first sound to be outputted as the reply. Next, the volume adjusting section 24 reads out, from the data table of the conversation scenario, an output value which is set in association with the speech which is the search result, and selects the output value as the volume of the first sound to be outputted from the sound output section 12. The output value is a volume value set in association with each speech of the robot 100 in the conversation scenario. The output value is stored in the data table of the conversation scenario (not shown).

In addition to the above method, there are variations of the method of adjusting the volume of the first sound by the volume adjusting section 24. In other words, the volume adjusting section 24 only needs to adjust the volume of the first sound (first element characterizing the first sound) on the basis of either the content of the text in the second sound of the partner robot or the volume of the second sound of the partner robot, which content and volume are obtained by the analysis by the sound analyzing section 21. The variations of the method of adjusting the volume will be described in more detail later.

The speech deciding section 25 searches the conversation scenario, which is stored in the scenario checking section 22, for the speech which is the reply to the speech identified by the scenario checking section 22. Then, the speech deciding section 25 generates text data of a sentence of the speech to be outputted from the robot 100 so that the speech, which is a search result, will be the content of the text in the first sound.

The sound synthesizing section 26 converts, into audio data, the text data of the sentence of the speech which is generated by the speech deciding section 25 (synthesizes a sound of the speech), and transmits, to the volume setting section 27, the audio data obtained as a result of conversion. The volume setting section 27 associates the audio data received from the sound synthesizing section 26 with the output value selected by the volume adjusting section 24, so that the volume of the first sound to be outputted as the reply is set. After the volume is set, the volume setting section 27 transmits the audio data and volume data (output value) to the sound output section 12.

<Characteristic Operations of Robot>

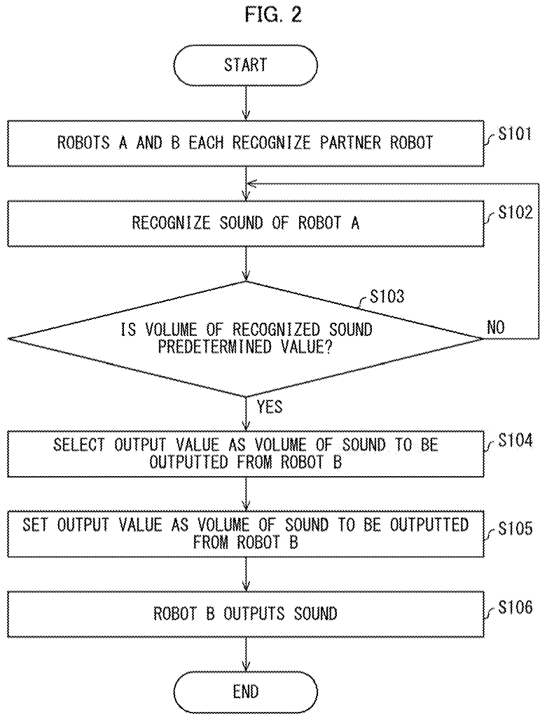

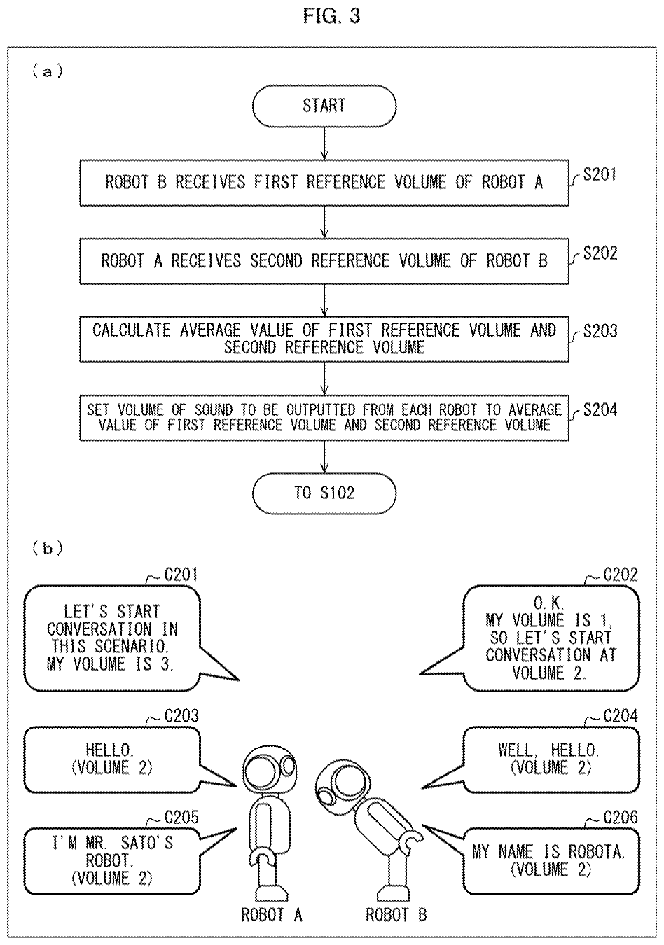

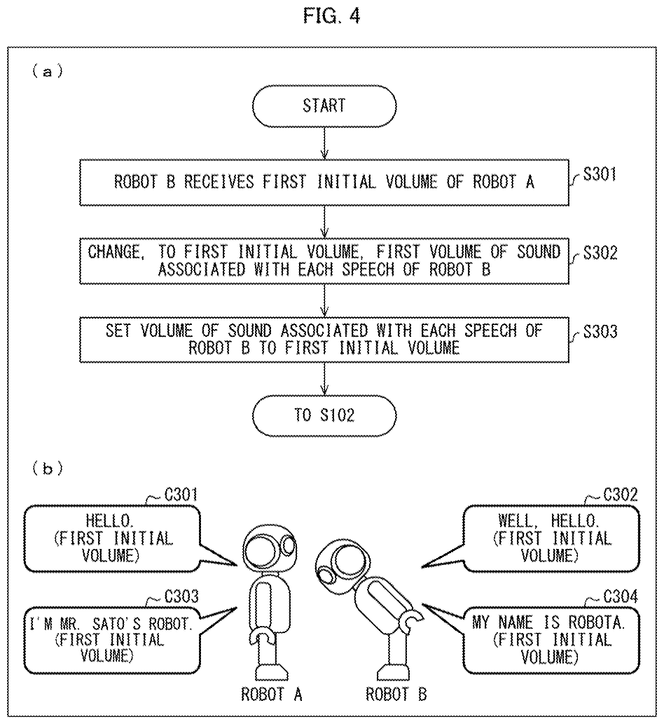

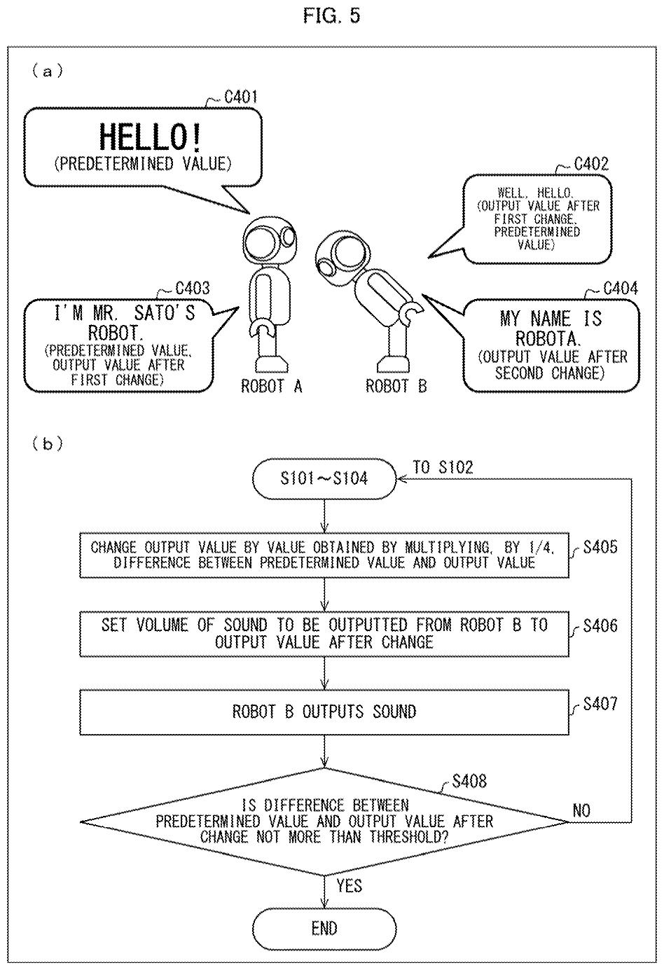

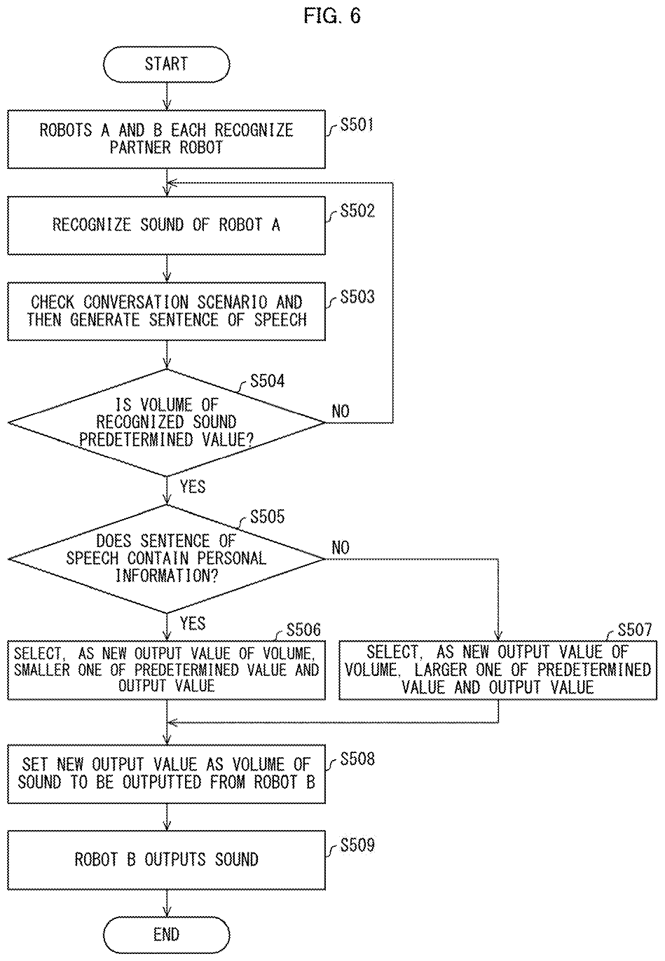

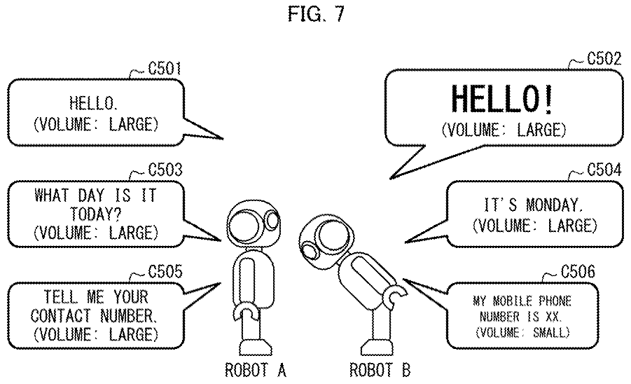

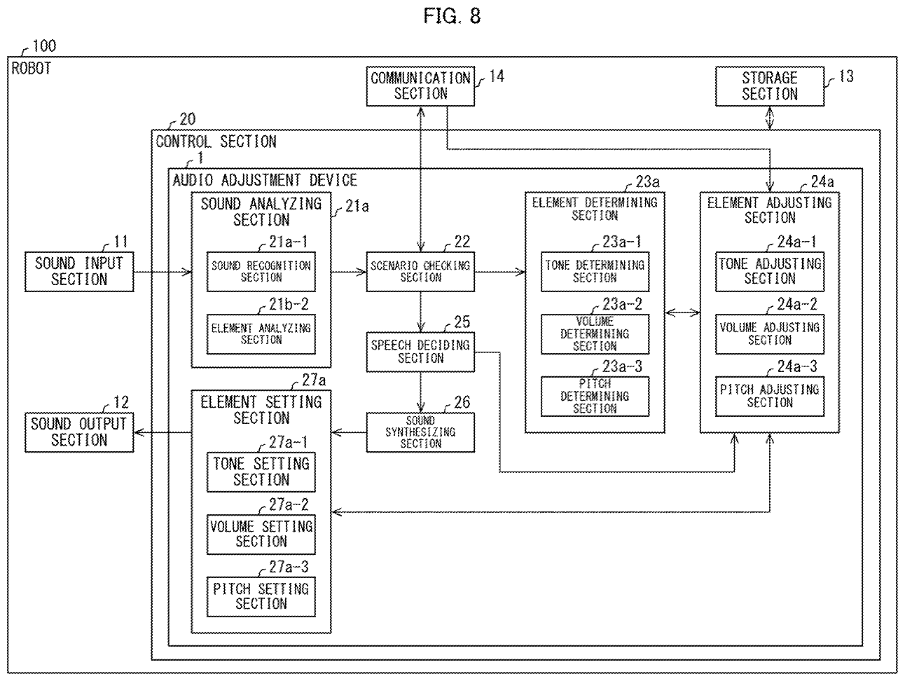

Next, the following will discuss characteristic operations of the robot 100, with reference to a flowchart of FIG. 2. FIG. 2 is a flowchart showing an example flow of characteristic operations of the robot 100. The following describes a case where two robots, i.e., a robot A and a robot B, which are each the robot 100, carry out a conversation with each other. The same applies to FIGS. 3 to 7.

First, when a connection of each of the two robots A and B is started, the operations in the flowchart of FIG. 2 start (START). The connection can be started by user's operation, such as by pressing a button, speaking a voice command, swinging a robot housing, etc., or can be started through a network server to which each of the robots A and B are connected via the communication section 14. Each of the robots A and B finds the other (partner robot) by a Wireless Local Area Network (WLAN), positional information, or Bluetooth (registered trademark), and establishes a communication protocol.

In step S101 (hereinafter, “step” will be omitted), the robots A and B recognize each other by exchanging, via the communication section 14, data of a conversation scenario to be reproduced, and the step proceeds to S102.

In S102 (the step of analyzing a sound), a sound (second sound) outputted from the robot A is inputted to the sound input section 11 of the robot B and converted into audio data. The audio data is transmitted to the sound analyzing section 21 of the robot B. The sound analyzing section 21 of the robot B analyzes sound information (sound recognition and volume analysis) of the sound outputted from the robot A. The sound analyzing section 21 then transmits a result of the sound recognition to the scenario checking section 22 of the robot B and a result of the volume analysis to the volume determining section 23 of the robot B. Thereafter, the step proceeds to S103.

In S103, the volume determining section 23 of the robot B determines, with regard to a volume of the sound of the robot A (second element characterizing the second sound) which sound has been analyzed by the sound analyzing section 21 of the robot B, whether or not the value is a predetermined value. In a case where a result of this determination in S103 is NO (hereinafter, abbreviated as “N”), the robot B performs the operation of S102 again.

On the other hand, in a case where the result of the determination in S103 is YES (hereinafter, abbreviated as “Y”), the volume determining section 23 of the robot B confirms that a content of a text in the sound of the robot A corresponds to one of speeches of the robot A in a conversation scenario, on the basis of the result of the determination in S103 and a result of identification by the scenario checking section 22. The volume determining section 23 of the robot B transmits a result of this confirmation to the volume adjusting section 24. Then, the step proceeds to S104.

In S104 (the step of adjusting an element), the volume adjusting section 24 of the robot B searches the conversation scenario for a speech which is a reply to a speech of the sound which speech of the sound is identified by the scenario checking section 22. Next, the volume adjusting section 24 of the robot B selects, as a volume of a sound to be outputted from the robot B (first element characterizing the first sound), an output value set in association with the speech which is a result of the above search. The volume adjusting section 24 of the robot B transmits the output value thus selected to the volume setting section 27. Then, the step proceeds to S105.

In S105, the volume setting section 27 of the robot B sets the volume of the sound to be outputted as the reply from the robot B to the output value selected above by the volume adjusting section 24. After the volume is set, the volume setting section 27 of the robot B transmits, to the sound output section 12, volume data (output value) and the like. Then, the step proceeds to S106. In S106, the sound output section 12 of the robot B outputs the sound of the volume which has been set by the volume setting section 27. Each of the robots A and B repeats the operations of S101 to S106 described above and thereby continues the conversation.

<Variations of Method of Adjusting Volume>

Next, the following will discuss variations of the method of adjusting the volume of the first sound by the volume adjusting section 24, with reference to FIGS. 3 to 7. (a) of FIG. 3 is a flowchart showing another example flow of characteristic operations of the robots A and B. (b) of FIG. 3 is a diagram showing an example of a conversation between the robots A and B.

In addition, (a) of FIG. 4, (a) of FIG. 5, and FIG. 6 are each a flowchart showing another example flow of characteristic operations of the robots A and B. (b) of FIG. 4, (b) of FIG. 5 and FIG. 7 are each a diagram showing another example of a conversation between the robots A and B.

First, as shown in FIG. 3, the robots A and B can be configured to (i) exchange data of reference volumes with each other when the robots A and B exchange data of a conversation scenario with each other, and (ii) set a volume of a sound for reproduction of a conversation scenario prior to starting a conversation. The reference volume of the robot A is a first reference volume, and the reference volume of the robot B is a second reference volume. The first reference volume is stored in advance in the storage section 13 of the robot A, or the like and the second reference volume is stored in advance in the storage section 13 of the robot B, or the like.

During the reproduction of the conversation scenario, the volume of the sound of the robot A is equal to the volume of the sound of the robot B. The volume of the sounds of the robots A and B is an average value of the first reference volume and the second reference volume. Upon receipt of data of the reference volume of the partner robot via the communication section 14, the average value is calculated by the volume adjusting section 24 of each of the robots A and B. The volume of the sounds of the robots A and B is constantly the average value for all of speeches of the robots A and B during the reproduction of the conversation scenario.

Note that the volume of the sounds during the reproduction of the conversation scenario does not necessarily have to be the average value of the first reference volume and the second reference volume, and can be any value that can be calculated with use of the first reference volume and the second reference volume.

The flowchart of (a) of FIG. 3 shows a flow of characteristic operations of the robots A and B carried out by using the above-described volume adjusting method. First, prior to starting the conversation, each of the robots A and B transmits its reference volume data to the partner robot. That is, the robot B receives the data of the first reference volume of the robot A (S201), and the robot A receives the data of the second reference volume of the robot B (S202). Then, the step proceeds to S203.

In S203, the volume adjusting section 24 of each of the robots A and B calculates the average value by using the data of the first or second reference volume which has been received. The volume adjusting section 24 transmits the average value thus calculated to the volume setting section 27 in the robot A or B. Then, the step proceeds to S204. In S204, the volume setting section 27 of each of the robots A and B sets the volume value of the sound to be outputted from the robot to the average value. The volume setting section 27 of each of the robots A and B transmits the volume thus set to the storage section 13 or the volume determining section 23, so that the step proceeds to S102 in the flowchart of FIG. 2.

The operations subsequent to S102 are substantially the same as those in the flowchart of FIG. 2. Note that the predetermined value in S103 and the output value in S104 each become the average value described above, and the operation of S105 is omitted. Also note that the operations of S104 to S106 are also performed by the robot A.

The diagram of (b) of FIG. 3 shows an example of a conversation between the robots A and B carried out by using the above-described volume adjusting method. First, as speech C201 (hereinafter, “speech” will be omitted), the robot A says, “Let's start the conversation in this scenario. My volume is 3”. Then, the speech proceeds to C202. As C202, the robot B replies, “O.K. My volume is 1, so let's start the conversation at volume 2”. Then, the speech proceeds to C203.

At this point, the robots A and B have completed exchange of the data of the reference volumes with each other and also calculation of the average value. The conversation between the robots A and B up to C202 is not a conversation scripted in the conversation scenario, but a preparatory conversation which is carried out for starting the conversation based on the conversation scenario. Accordingly, speeches subsequent to C203 correspond to speeches in the conversation scenario.

As C203, the robot A says, “Hello”. Since the volume of the sound associated with this speech is the average value, the speech proceeds to C204. For respective speeches of C204 to C206, the volume of all sounds is the average value, and the conversation scripted in the conversation scenario accordingly continues to the end.

Next, as shown in FIG. 4, it is also possible to configure such that (i) either the robot A or the robot B transmits, to the partner robot (the other robot), data of a volume of a sound associated with a first speech (hereinafter, referred to as “initial volume”) out of speeches of that robot A or B, which speeches are scripted in a conversation scenario and then, (ii) the partner robot sets a volume of a sound of a speech of the partner robot to the initial volume. The initial volume of the robot A is referred to as a first initial volume, and the initial volume of the robot B is referred to as a second initial volume. The first initial volume is stored in advance in the storage section 13 of the robot A, or the like, and the second initial volume is stored in advance in the storage section 13 of the robot B, or the like.

It is alternatively possible to configure such that the robot A or B that has recognized the sound of the first speech of the partner robot calculates a volume of a sound actually outputted first by the partner robot. This calculation is based on, for example, the volume of the sound which has been recognized and a distance to the partner robot. Then, the robot A or B which has calculated the volume can set, to the volume thus calculated, the volume of the sound associated with the speech of the partner robot. The distance to the partner robot is measured, for example, on the basis of positional information, or by using an optical method such as a camera section 15 (described later) or infrared rays.

The flowchart of (a) of FIG. 4 shows a flow of characteristic operations of the robots A and B carried out by using the above-described volume adjusting method. Note that with reference to (a) of FIG. 4, the following will discuss how the volume of the sound associated with the speech of the partner robot is set to the initial volume.

First, prior to starting a conversation, the robot A transmits data of the first initial volume to the robot B (S301). In S302, the volume adjusting section 24 of the robot B having received the data of the first initial volume changes, to the first initial volume, volumes of all sounds associated with respective speeches of the robot B including the second initial volume. The volume adjusting section 24 of the robot B transmits, to the volume setting section 27 of the robot B, the first initial value to which the volumes are changed. Then, the step proceeds to S303. In S303, the volume setting section 27 of the robot B sets the volume of the sound to be outputted from the robot B to the first initial volume. Then, the volume setting section 27 of the robot B transmits the volume thus set to the storage section 13 or the volume determining section 23. Then, the step proceeds to S102 in the flowchart of FIG. 2.

The operations subsequent to S102 are substantially the same as those in the flowchart of FIG. 2. Note that the predetermined value in S103 and the output value in S104 each become the first initial volume described above, and the operation of S105 is omitted.

Further, the diagram of (b) of FIG. 4 shows an example of a conversation between the robots A and B carried out by using the above-described volume adjusting method. Before the robot A speaks the text of C301, which is scripted in the conversation scenario as the first speech of the robot A, the data of the first initial volume is transmitted to the robot B. Then, volumes of all sounds associated with respective speeches of the robot B are changed to the first initial volume.

As C301, the robot A says, “Hello”. Since the volume of the sound associated with this speech is the first initial volume, the speech proceeds to C302. For respective speeches of C302 to C304, the volume of all sounds is the first initial volume, and the conversation scripted in the conversation scenario accordingly continues to the end.

Next, as shown in FIG. 5, respective volumes of sounds of the robots A and B can be adjusted so that a difference between the volume of the sound outputted from the robot A and the volume of the sound outputted from the robot B decreases each time the robots A and B move the conversation following the conversation scenario.

For example, immediately before the robot A or B speaks a text of each speech in the conversation scenario, the volume adjusting section 24 of that robot A or B changes an output value of that robot A or B by a value obtained by multiplying, by ¼, a difference between the predetermined value of the partner robot and the output value of the robot A or B. Then, the robot A or B outputs a sound of the output value after this change. The robots A and B each change the output value for each speech. Subsequently, the conversation between the robots A and B can be ended when the difference between the predetermined value of the partner robot and the output value of the robot A or B becomes not more than a predetermined threshold value.

Note that the output value after the change can be transmitted to the partner robot via the communication section 14 every time the sound of the output value after the change is outputted. Alternatively, the volume adjusting section 24 of the robot A or B can be configured to (i) calculate a volume of a sound actually outputted from the partner robot, on the basis of the volume of the sound recognized by that robot A or B and a distance to the partner robot, and (ii) change the output value on the assumption that the volume thus calculated is the volume (predetermined value) of the sound associated with the speech of the partner robot.

The above-described method of calculating a new output value is merely an example. It is alternatively possible, for example, (i) to calculate, by the volume adjusting section 24, a value close to an average value of (a) an output value of a previous speech of the robot A or B and (b) a predetermined value of a current speech of the partner robot, and (ii) use the value close to the average value as the output value after the change. The value close to the average value is a value obtained by selecting either an integer value closer to the predetermined value of the partner robot or an integer value closer to the output value of the robot A or B with reference to the average value in a case where there is, for example, a constraint that only an integer value can be set as the volume value.

The flowchart of (a) of FIG. 5 shows a flow of characteristic operations of the robots A and B by using the above-described volume adjusting method. First, the flow of the operations is similar to that from S101 to S104 in the flowchart of FIG. 2 until the volume adjusting section 24 of the robot B selects the output value.

In S405, the volume adjusting section 24 of the robot B changes the output value by a value (hereinafter, referred to as an “adjustment value”) obtained by multiplying, by ¼, the difference between the predetermined value and the output value selected. The output value is changed so that the difference between the predetermined value and the output value will be smaller. In a case where the predetermined value is larger than the output value selected, the adjustment value is added to the output value. On the other hand, in a case where the predetermined value is smaller than the output value selected, the adjustment value is subtracted from the output value. The volume adjusting section 24 of the robot B transmits the output value after this change to the volume setting section 27. Then, the step proceeds to the S406.

In S406, the volume setting section 27 of the robot B sets the volume of the sound to be outputted from the robot B to the output value after the change. The volume setting section 27 of the robot B transmits, to the sound output section 12, volume data (output value after change) and the like which has been set by the volume setting section 27 of the robot B. Then, the step proceeds to S407. In S407, the sound output section 12 of the robot B outputs the sound of the volume which has been set by the volume setting section 27. Then, the volume setting section 27 of the robot B transmits the volume thus set to the volume adjusting section 24, so that the step proceeds to S408.

In S408, the volume adjusting section 24 of the robot B determines whether or not the difference between the predetermined value and the output value after the change is not more than the threshold value. In a case where a result of this determination in S408 is Y, the robots A and B end the operations (END). On the other hand, in a case where the result of the determination in S408 is N, the robot B performs the operation of S102 again. Each of the robots A and B repeats the operations of S102 to S408 described above and thereby continues the conversation.

The diagram of (b) of FIG. 5 shows an example of a conversation between the robots A and B carried out by using the above-described volume adjusting method. First, as C401, the robot A says, “Hello! (volume: predetermined value)”. Then, the speech proceeds to C402. As C402, the robot B replies, “Well, hello (volume: output value after first change (predetermined value))”. Here, since the difference between the predetermined value of the robot A and the output value of the robot B after the first change is larger than the threshold value, the speech proceeds to C403.

As C403, the robot A says, “I'm Mr. Sato's robot (volume: predetermined value (output value after first change))”. Here, since the difference between the predetermined value of the robot B (the output value after the first change) and the output value of the robot A after the first change (the predetermined value) is larger than the threshold value, the speech proceeds to C404.

As C404, the robot B says, “My name is Robota (volume: output value after second change)”. Here, since the difference between the predetermined value of the robot A (output value after first change) and the output value of the robot B after the second change becomes not more than the threshold value, the conversation between the robots A and B ends.

Alternatively, as shown in FIGS. 6 and 7, the volume adjusting section 24 can adjust the volume of the robot A or B in accordance with a content of a conversation between the robots A and B. For example, when the robot A or B speaks, the volume adjusting section 24 of each of the robots A and B checks text data of a sentence of a speech, which text data is generated by the speech deciding section 25, and determines whether or not the sentence of the speech contains designated data which has been designated in advance as personal data.

Examples of the designation data encompass telephone number, mail address, birthday, hometown, and current address. On the other hand, the current time, today's date, today's day of the week, today's weather, pre-installed data, and the like are examples of information which are not designated data. In addition, the designated data can encompass negative words such as “boring” and “disgusting” in addition to the personal information mentioned above. The designated data is stored in advance in the form of a data table (not shown) in the storage section 13 of each of the robots A and B.

In a case where it is determined that the designated data is contained in the sentence of the speech, the volume adjusting section 24 sets the volume of the sound to be outputted to a smaller one of the predetermined value and the output value. On the other hand, in a case where it is determined that no designated data is contained, the volume adjusting section 24 sets the volume of the sound to be outputted to a larger one of the predetermined value and the output value. Such adjustment makes it possible to continue a natural, humanlike conversation between the robots A and B while preventing, to some extent, personal data in the conversation from leaking to a user and a third person.

Note that in a case where, for example, no speech containing personal data exists in a conversation scenario, an appropriate volume can be set in advance for each speech in the conversation scenario in view of a content of the speech, and volume data of each speech can be stored in the storage section 13 of each of the robots A and B, or the like.

Further, for example, the volume of the sound to be outputted from each of the robots A and B can be adjusted in consideration of (a) the content of the conversation between the robots A and B and (b) the volume of the sound outputted from that robot A or B. Specifically, immediately before the robot A or B speaks the text of each speech in the conversation scenario, the volume adjusting section 24 of that robot A or B changes the output value by a value obtained by multiplying, by ¼, the difference between the predetermined value of the partner robot and the output value of the robot A or B (first output value). Further, the volume adjusting section 24 of that robot A or B selects either the predetermined value or the output value in accordance with the content of the conversation (second output value).

Then, the volume adjusting section 24 of each of the robots A and B calculates the volume of the sound to be outputted, by summing (a) a value obtained by multiplying the first output value by cos θ and (b) a value obtained by multiplying the second output value by sin θ. Note that the angle θ is appropriately set to an angle in a range of 0 degrees to 90 degrees.

The flowchart of FIG. 6 shows a flow of characteristic operations of the robots A and B by using the above-described volume adjusting method. First, the operations of S501 and S502 are similar to the operations of S101 and S103 in the flowchart of FIG. 2.

In S503, the scenario checking section 22 of the robot B checks the conversation scenario and transmits a check result to the speech deciding section 25. The speech deciding section 25 of the robot B, which has received the check result, generates text data of a sentence of a speech, and transmits the text data thus generated to the volume adjusting section 24. Then, the step proceeds to S504. The operation of S504 is similar to that in S103 in the flowchart of FIG. 2.

In S505, the volume adjusting section 24 of the robot B, which has received the text data generated, determines whether or not the sentence of the speech contains designated data concerning personal data. In a case where a result of determination in S505 is Y, the volume adjusting section 24 of the robot B selects, as a new output value, a smaller one of the predetermined value and the output value (S506).

On the other hand, in a case where the result of determination in S505 is N, the volume adjusting section 24 of the robot B selects, as the new output value, a larger one of the predetermined value and the output value (S507). The volume adjusting section 24 of the robot B transmits the new output value thus selected to the volume setting section 27. Then, the step proceeds to S508. The operations of S508 and S509 are similar to those of S105 and S106 in the flowchart of FIG. 2.

FIG. 7 shows an example of a conversation between the robots A and B by using the above-described volume adjusting method. Contents of speeches of C501 through C505 do not contain personal data. Therefore, the larger one of the predetermined value and the outputted value is selected for all volumes of sounds associated with the speeches.

As C506, the robot B says, “The mobile phone number is XX”. The speech contains, in the portion “XX”, the mobile phone number which is the designated data. Therefore, for the volume of the sound associated with the speech of C506, the smaller one of the predetermined value and the outputted value is selected. In this way, the conversation scripted in the conversation scenario continues to the end.

<Functional Configuration of Robots According to Variation of Embodiment 1>

Next, the following will discuss a functional configuration of a robot 100 according to a variation of Embodiment, with reference to FIG. 8. FIG. 8 is a block diagram illustrating the functional configuration of the robot 100 according to the variation of Embodiment 1.

The audio adjustment device 1 built in the robot 100 according to Embodiment 1 adjusts a volume of a first sound so that a natural, humanlike conversation is carried out between the robot 100 and a partner robot. However, the first sound need not necessarily be adjusted by adjusting only the volume of the first sound. The first sound can be adjusted by adjusting another element(s) characterizing the first sound.

For example, the first sound can be adjusted by adjusting either “tone” or “pitch” of the first sound. Alternatively, the first sound can be adjusted by adjusting two or more elements out of “volume”, “tone” and “pitch” of the first sound in an appropriate combination.

As an example of the robot 100 capable of realizing the above-described sound adjustment, there is a robot 100 as illustrated in, for example, FIG. 8. The robot 100 includes a built-in audio adjustment device 1 which includes a sound analyzing section 21a instead of the sound analyzing section 21, an element determining section 23a instead of the volume determining section 23, an element adjusting section 24a instead of the volume adjusting section 24, and an element setting section 27a instead of the volume setting section 27.

The sound analyzing section 21a has a function similar to that of the sound analyzing section 21, and includes a sound recognition section 21a-1 and an element analyzing section 21b-2. The element analyzing section 21b-2 analyzes audio data of a single speech of the partner robot, which audio data has been received from the sound input section 11, and obtains volume data, tone data, and pitch data of this single speech. Note that the element analyzing section 21b-2 does not necessarily have to obtain all of these three kinds of element data. The element analyzing section 21b-2 can obtain either the tone data or the pitch data or obtain any two out of the three kinds of element data.

The element determining section 23a includes a tone determining section 23a-1, a volume determining section 23a-2, and a pitch determining section 23a-3. On the basis of determination results obtained by these three determination sections, the element determining section 23a determines, with regard to elements (“volume”, “tone”, and “pitch”: second elements) characterizing the second speech of the partner robot which elements have been recognized by the sound analyzing section 21, whether or not these elements are predetermined values. The predetermined values are respective values of three elements which values are set in association with each speech of the partner robot in a conversation scenario. The predetermined values are stored in a data table of the conversation scenario (not shown).

In a case where all of the tone determining section 23a-1, the volume determining section 23a-2, and the pitch determining section 23a-3 determine, respectively, that the elements characterizing the second sound are the predetermined values, the element determining section 23a confirms that the content of the second sound of the partner robot is one of speeches of the partner robot in the conversation scenario. It should be noted that the element determining section 23a does not need to determine whether or not all of the elements characterizing the second sound of the partner robot are the predetermined values, and can determine whether any one or more of the above elements characterizing the second sound is a corresponding predetermined value, in accordance with the characteristic of the second sound, the content of the conversation scenario, and/or the like.

The element adjusting section 24a includes a tone adjusting section 24a-1, a volume adjusting section 24a-2, and a pitch adjusting section 24a-3. The element adjusting section 24a adjusts the first sound by adjusting each of elements (“volume”, “tone”, and “pitch”: first elements) characterizing the first sound by the above three adjusting sections.

Each of the elements characterizing the first sound can be adjusted by any adjustment method. Examples of the method of adjusting each element characterizing the first sound encompass: (a) a method in which a target value of each element is set in advance for each speech constituting the conversation scenario and stored in the storage section 13 or the like; (b) a method in which an average value of a value of each element of the first sound of the robot 100 and a value of a corresponding element of the second sound outputted from the partner robot is calculated, and the average value is then used as the value of the each element of the first sound to be outputted from the robot 100; and (c) a method in which the value of each element characterizing the first sound is arranged to gradually approach the target value as the conversation progresses, as in the case of the variation of the volume adjustment shown in FIG. 5.

Note that the element adjusting section 24a does not need to adjust all of the elements characterizing the first sound of the robot 100. The element adjusting section 24a can adjust any one or more of the above-mentioned elements, in accordance with the characteristic of the first sound, the content of the conversation scenario, and the like.

The element setting section 27a includes a tone setting section 27a-1, a volume setting section 27a-2, and a pitch setting section 27a-3. The element setting section 27a associates the audio data received from the sound synthesizing section 26 with the value of each element characterizing the first sound which element has been adjusted by the element adjusting section 24a, so that the value of the each element of the first sound to be outputted as a reply is set to the value adjusted.

### Embodiment 2

The following will discuss another embodiment of the present invention, with reference to FIG. 1. For convenience of description, members having the same functions as those of the members described in Embodiment 1 are denoted by the same reference numerals, and descriptions thereof are omitted. A robot 200 according to Embodiment 2 differs from the robot 100 according to Embodiment 1 in that the robot 200 includes a camera section 15 and a built-in audio adjustment device 2 which includes a conversation state detecting section 28.

<Functional Configuration of Robot>

The following will discuss a functional configuration of the robot 200, with reference to FIG. 1. FIG. 1 is a block diagram illustrating the functional configuration of the robot 200. The robot 200 (first electronic apparatus, or electronic apparatus), like the robot 100, is a communication robot capable of carrying out a conversation with a partner robot.

The camera section 15 is an image pickup section for capturing an image of an object. The camera section 15 is built in, for example, each of two eye portions (not shown) of the robot 200. The image of the partner robot captured by the camera section 15 is transmitted as data of a captured image to the conversation state detecting section 28. The data of the captured image of the partner robot is transmitted, for example, at a time point when the robot 200 and the partner robot exchange with each other data of a conversation scenario to be reproduced via a communication section 14 and each of the robot 200 and the partner robot recognizes the other robot (partner robot) as a conversation partner (see S101 of FIG. 2).

The conversation state detecting section 28 analyzes the data of the captured image which data has been transmitted from the camera section 15, and thereby detects whether or not the partner robot is ready for conversation with the robot 200. The conversation state detecting section 28 detects, for example, a ratio of an image of the partner robot in the captured image, a position where the image of the partner robot is located in the captured image, whether the image of the partner robot is facing the robot 200, and the like, by analyzing the data of the captured image.

In a case where the conversation state detecting section 28 detects, as a result of the above analysis, that the partner robot is ready for conversation with the robot 200, the conversation state detecting section 28 transmits this result of the analysis to a volume adjusting section 24. The volume adjusting section 24, which has received the result of the analysis, adjusts a volume of a first sound to be outputted from the sound output section 12 in accordance with a confirmation result which is received from a volume determining section 23. That is, in a case where the conversation state detecting section 28 determines that the partner robot is ready for conversation with the robot 200, the volume adjusting section 24 adjusts the volume of the first sound to be outputted from the sound output section 12.

It should be noted that the conversation state detecting section 28 can be, for example, an external device attached to the robot 200 or a network server used via the communication section 14.

### Embodiment 3

Control blocks of an audio adjustment device 1, 2 (particularly, volume determining section 23 and volume adjusting section 24) can be realized by a logic circuit (hardware) provided in an integrated circuit (IC chip) or the like or can be alternatively realized by software as executed by a central processing unit (CPU).

In the latter case, the audio adjustment device 1, 2 includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to or made available to the computer via any transmission medium (such as a communication network or a broadcast wave) which allows the program to be transmitted. Note that an aspect of the present invention can also be achieved in the form of a computer data signal in which the program is embodied via electronic transmission and which is embedded in a carrier wave.

[Recap]

An audio adjustment device (1, 2) according to Aspect 1 of the present invention is an audio adjustment device for adjusting a first sound to be outputted from a first electronic apparatus (robot 100), the audio adjustment device including: a sound analyzing section (21, 21a) for analyzing a second sound outputted from a second electronic apparatus; and an element adjusting section (volume adjusting section 24 or 24a-2, 24a) for adjusting a first element characterizing the first sound, the first element being adjusted on a basis of either a content of a text in the second sound or a second element characterizing the second sound, the content of the text in the second sound and the second element being obtained by analysis by the sound analyzing section.

According to the above configuration, the element adjusting section adjusts the first element of the first sound to be outputted from the first electronic apparatus, on the basis of either the content of the text in the second sound or the second element of the second sound, which second sound has been outputted from the second electronic apparatus. Therefore, the element adjusting section adjusts the volume of the first sound so that, for example, the volume of the first sound will be equal to the volume of the second sound having been outputted from the second electronic apparatus. This allows a natural, humanlike conversation to be carried out between the first electronic apparatus and the second electronic apparatus.

An audio adjustment device according to Aspect 2 of the present invention is configured preferably to further include, in Aspect 1, an element determining section (sound determining section 23 or 23a-2, 23a) for determining whether the second element characterizing the second sound satisfies a predetermined condition, the element adjusting section adjusting the first element in a case where the element determining section determines that the second element satisfies the predetermined condition.

According to the above configuration, the element adjusting section does not adjust the first element in a case where the second element does not satisfy the predetermined condition. This can prevent unnecessary adjustment of the first element. In other words, the configuration prevents, for example, a situation in which the element adjusting section adjusts the first element even in a case where the second electronic apparatus is speaking to another device or the like which is not the first electronic apparatus. Therefore, the configuration reliably allows a natural, humanlike conversation to be carried out between the first electronic apparatus and the second electronic apparatus.

An audio adjustment device according to Aspect 3 of the present invention is configured preferably to further include, in Aspect 1 or 2, a scenario checking section (22) for identifying which speech in a conversation scenario the content of the text in the second sound corresponds to, the conversation scenario showing speeches to be exchanged between the first electronic apparatus and the second electronic apparatus, the element adjusting section (i) searching the conversation scenario for a speech which is a reply to the speech identified by the scenario checking section, (ii) specifying the speech, which is a search result, for a content of a text in the first sound, and (iii) adjusting the first element characterizing the first sound on a basis of the content thus specified.

According to the above configuration, the element adjusting section adjusts the first element associated with the speech of the first electronic apparatus, which speech is a reply to the speech of the second electronic apparatus in the conversation scenario. This more reliably allows a natural, humanlike conversation to be carried out between the first electronic apparatus and the second electronic apparatus, since the first element can be adjusted in accordance with the content of each speech in the conversation scenario.

An audio adjustment device (2) according to Aspect 4 of the present invention is configured preferably to further include, in any one of Aspects 1 to 3, a conversation state detecting section (28) for detecting whether or not the second electronic apparatus is ready for conversation with the first electronic apparatus, the element adjusting section adjusting the first element in a case where the conversation state detecting section determines that the second electronic apparatus is ready for the conversation.

According to the above configuration, in a case where the second electronic apparatus is not ready for conversation with the first electronic apparatus, the element adjusting section does not adjust the first element. This can prevent unnecessary adjustment of the first element. In other words, the configuration prevents, for example, a situation in which the element adjusting section adjusts the first element even in a case where (i) the first electronic apparatus and the second electronic apparatus are apart from each other and (ii) in view of a relative positional relationship between the first electronic apparatus and the second electronic apparatus, it does not appear to a person that the first electronic apparatus and the second electronic apparatus are ready for conversation with each other. Therefore, the configuration more reliably allows a natural, humanlike conversation to be carried out between the first electronic apparatus and the second electronic apparatus.

An audio adjustment device (1, 2) according to Aspect 5 of the present invention is configured preferably such that in any one of Aspects 1 to 4, the first element is a volume of the first sound; and the second element is a volume of the second sound. According to the above configuration, a natural, humanlike conversation can be carried out between the first electronic apparatus and second electronic apparatus, by adjusting, with use of the element adjusting section, the volume of the first sound to be outputted from the first electronic apparatus.

An electronic apparatus (robot 100, 200) according to Aspect 6 of the present invention is an electronic apparatus for adjusting a first sound to be outputted from the electronic apparatus, the electronic apparatus including: a sound analyzing section (21, 21a) for analyzing a second sound outputted from an external electronic apparatus; and an element adjusting section (volume adjusting section 24, 24a) for adjusting a first element characterizing the first sound, the first element being adjusted in accordance with either a content of a text in the second sound or a second element characterizing the second sound, the content of the text in the second sound and the second element being obtained by analysis by the sound analyzing section. This configuration makes it possible to provide an electronic apparatus capable of carrying out a natural, humanlike conversation with an external electronic apparatus.

A control method for controlling an audio adjustment device according to Aspect 7 of the present invention is a method for controlling an audio adjustment device for adjusting a first sound to be outputted from a first electronic apparatus, the control method including the steps of: analyzing a second sound having been outputted from a second electronic apparatus; and adjusting a first element characterizing the first sound, the first element being adjusted on a basis of either a content of a text in the second sound or a second element characterizing the second sound, the content of the text in the second sound and the second element having been obtained by analysis in the step of analyzing the second sound. The above configuration makes it possible to realize a method for controlling an audio adjustment device which method allows a natural, humanlike conversation to be carried out between the first electronic apparatus and the second electronic apparatus.

The audio adjustment device according to each aspect of the present invention may be realized by a computer. In this case, the scope of each aspect of the present invention encompasses (a) a control program of the audio adjustment device, which control program causes a computer to function as the above audio adjustment device by causing the computer to function as each section (software element) of the audio adjustment device, and (b) a computer-readable recording medium storing the control program therein.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 2: Audio adjustment device
21: Sound analyzing section
22: Scenario checking section
23, 23a-2: Volume determining section (element determining section)
23a: Element determining section
23a-1: Tone determining section (element determining section)
23a-3: Pitch determining section (element determining section)
24, 24a-2: Volume adjusting section (element adjusting section)
24a: Element adjusting section
24a-1: Tone adjusting section (element adjusting section)
24a-3: Pitch adjusting section (element adjusting section)
28: Conversation state detecting section

1. An audio adjustment device for adjusting a first sound to be outputted from a first electronic apparatus, the audio adjustment device comprising:
a sound analyzing section for analyzing a second sound outputted from a second electronic apparatus; and
an element adjusting section for adjusting a first element characterizing the first sound, the first element being adjusted on a basis of either a content of a text in the second sound or a second element characterizing the second sound, the content of the text in the second sound and the second element being obtained by analysis by the sound analyzing section.

2. The audio adjustment device as set forth in claim 1, further comprising:
an element determining section for determining whether the second element characterizing the second sound satisfies a predetermined condition,
the element adjusting section adjusting the first element in a case where the element determining section determines that the second element satisfies the predetermined condition.

3. The electronic apparatus as set forth in claim 1, further comprising:
a scenario checking section for identifying which speech in a conversation scenario the content of the text in the second sound corresponds to, the conversation scenario showing speeches to be exchanged between the first electronic apparatus and the second electronic apparatus,
the element adjusting section (i) searching the conversation scenario for a speech which is a reply to the speech identified by the scenario checking section, (ii) specifying the speech, which is a search result, for a content of a text in the first sound, and (iii) adjusting the first element characterizing the first sound on a basis of the content thus specified.

4. The audio adjustment device as set forth in claim 1, further comprising:
a conversation state detecting section for detecting whether or not the second electronic apparatus is ready for conversation with the first electronic apparatus,
the element adjusting section adjusting the first element in a case where the conversation state detecting section determines that the second electronic apparatus is ready for the conversation.

5. The audio adjustment device as set forth in claim 1, wherein:
the first element is a volume of the first sound; and
the second element is a volume of the second sound.

6. A computer-readable non-transitory storage medium storing a control program for causing a computer to function as an audio adjustment device as recited in claim 1, the control program causing the computer to function as the sound analyzing section and the element adjusting section.

7. An electronic apparatus for adjusting a first sound to be outputted from the electronic apparatus, the electronic apparatus comprising:
a sound analyzing section for analyzing a second sound outputted from an external electronic apparatus; and
an element adjusting section for adjusting a first element characterizing the first sound, the first element being adjusted in accordance with either a content of a text in the second sound or a second element characterizing the second sound, the content of the text in the second sound and the second element being obtained by analysis by the sound analyzing section.

8. A method for controlling an audio adjustment device for adjusting a first sound to be outputted from a first electronic apparatus, the control method comprising the steps of:
analyzing a second sound having been outputted from a second electronic apparatus; and
adjusting a first element characterizing the first sound, the first element being adjusted on a basis of either a content of a text in the second sound or a second element characterizing the second sound, the content of the text in the second sound and the second element having been obtained by analysis in the step of analyzing the second sound.
